(19) United States
(12) Patent Application Publication
(10) Pub. No.: US 2017/0123819 A1
(43) Pub. Date: May 4, 2017

(54) METHOD AND ELECTRONIC DEVICE FOR APPLICATION PROGRAM RECOMMENDATION

(71) Applicants: Le Holdings (Beijing) Co., Ltd., Beijing (CN); Lemobile Information Technology (Beijing) Co., Ltd., Beijing (CN)

(72) Inventor: Junkai YIN, Beijing (CN)

(21) Appl. No.: 15/246,484

(22) Filed: Aug. 24, 2016

Related U.S. Application Data
(63) Continuation of application No. PCT/CN2016/088454, filed on Jul. 4, 2016.

(30) Foreign Application Priority Data
Oct. 30, 2015 (CN) 2015107329673

(51) Int. Cl. G06F 9/44; H04M 1/725

(52) U.S. Cl. CPC G06F 9/4443; H04M 1/72519; G06F 3/04817

(57) ABSTRACT

The present invention discloses a method and electronic device for application program recommendation. The method includes: averagely dividing the time of a day into multiple periods of time, and counting the frequencies of using different application programs by a user in each period of time; successively ranking the use frequencies of the different application programs in each period of time from high to low, and recording the ranking sequence; and when no other recommended contents exist on the mobile phone screen, displaying the shortcuts of the top N application programs in term of usage frequency in the current period of time at preset positions of the mobile phone screen. According to the present invention, icons of the application programs are displayed on the mobile phone screen according to the use frequencies, so as to ensure that the user can start Apps fast enough.

### CROSS REFERENCE TO RELATED APPLICATIONS

This application is a continuation of International Application No. PCT/CN2016/088454, filed on Jul. 4, 2016 which is based upon and claims priority to Chinese Patent Application No. 201510732967.3, filed on 30 Oct. 2015, the entire contents of which are incorporated herein by reference.

### TECHNICAL FIELD

The present invention relates to the technical field of information technology, and specifically relates to a method and electronic device for application program recommendation.

### BACKGROUND

Nowadays, under the background of the continuous development of information technology, the use of smart phones by the public becomes more and more personalized and application functions of the smart phones are also extensively increased. A smart phone, like a personal computer, has become an intelligent device which has an independent operating system and an independent operation space, which allows users to install programs by themselves. Such programs are provided by third-party service providers, such as software, games, navigation and the like, and the smart phone can implement network access through a mobile communication network.

More and more users use mobile phones for daily information inquiry, daily work, interpersonal communication, entertainment and leisure. For example, many people have a habit of checking the weather forecast through a weather APP (application program) after getting up in the morning, ordering lunch through a takeout APP when taking a rest at noon, chatting with friends through a communication APP after work in the evening, and so on, and people need to use different APPs at different times.

In the above-mentioned conventional art, a large amount of APPs installed in mobile phones of many users result in that the mobile phone desktop displaying the APPs is as long as the number of pages, and part of the users, in order to simplify the mobile phone desktop, store the APPs of the same type or many APPs in the same file folder on the desktop. However, regardless of the former or the latter, when needing to use a certain APP, the user has to come to the mobile phone desktop to find the required APP page by page or from different folders.

The above two ways are likely to take a longer time for finding an APP by users, and also are very inconvenient for the users to use, resulting in poor user experience. Therefore, the prior art is lack of a method capable of actively presenting a probably required APP for a user on the mobile phone screen.

### SUMMARY

In order to solve the technical problem existing in the prior art that an application program cannot be recommended to a user according to the habit of the user, the present invention provides a method and electronic device for application program recommendation.

In an aspect, a method for application program recommendation according to an embodiment of the present invention includes: dividing the time of a day averagely into multiple periods of time, and counting the frequencies of using different application programs by a user in each period of time; successively ranking the use frequencies of the different application programs from high to low in each period of time, and recording the ranking sequence; and when no other recommended contents exist on the mobile phone screen, displaying, at preset positions of the mobile phone screen, the shortcuts of the top N application programs in term of usage frequency in the current period of time.

In another aspect, an electronic device for application program recommendation according to an embodiment of the present invention includes: at least one processor; and a memory communicably connected with the at least one processor for storing instructions executable by the at least one processor. The execution of the instructions by the at least one processor causes the at least one processor to: averagely divide the time of a day into multiple periods of time, and count the frequencies of using different application programs by a user in each period of time; successively rank the use frequencies of the different application programs in each period of time from high to low, and record the ranking sequence; and when no other recommended contents exist on the mobile phone screen, display the shortcuts of the top N application programs in term of usage frequency in the current period of time at preset positions of the mobile phone screen.

In another aspect, a non-transitory computer-readable storage medium is provided. The storage medium stores executable instructions that, when executed by an electronic device with a touch-sensitive display, cause the electronic device to: averagely divide the time of a day into multiple periods of time, and count the frequencies of using different application programs by a user in each period of time; successively rank the use frequencies of the different application programs in each period of time from high to low, and record the ranking sequence; and when no other recommended contents exist on the mobile phone screen, display the shortcuts of the top N application programs in term of usage frequency in the current period of time at preset positions of the mobile phone screen.

Other characteristics and advantages of the present invention will be stated in the description below, and partially become apparent in the description, or will be understood by implementation of the present invention. The purpose and other advantages of the present invention can be achieved and obtained through structures specified in the written description, claims, and accompanying drawings.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a work flow diagram of the embodiment I of the present invention;

FIG. 2 is a mobile phone screen display diagram in the prior art;

FIG. 3 is a mobile phone screen display diagram in the present invention; and

FIG. 4 is a schematic diagram of the structure of a device in the embodiment II of the present invention.

FIG. 5 is a block diagram of an electronic device which can implement a method for application program recommendation according to the present invention.

### DETAILED DESCRIPTION

Hereinafter, with reference to the accompanying drawings, the specific embodiments of the present invention are described in details, and it will be appreciated that the protection scope of the present invention is not limited by the specific embodiments.

In order to solve the technical problem existing in the prior art that an application program cannot be recommended to a user according to the habit of the user, the present invention provides a method and electronic device for application program recommendation.

### Embodiment I

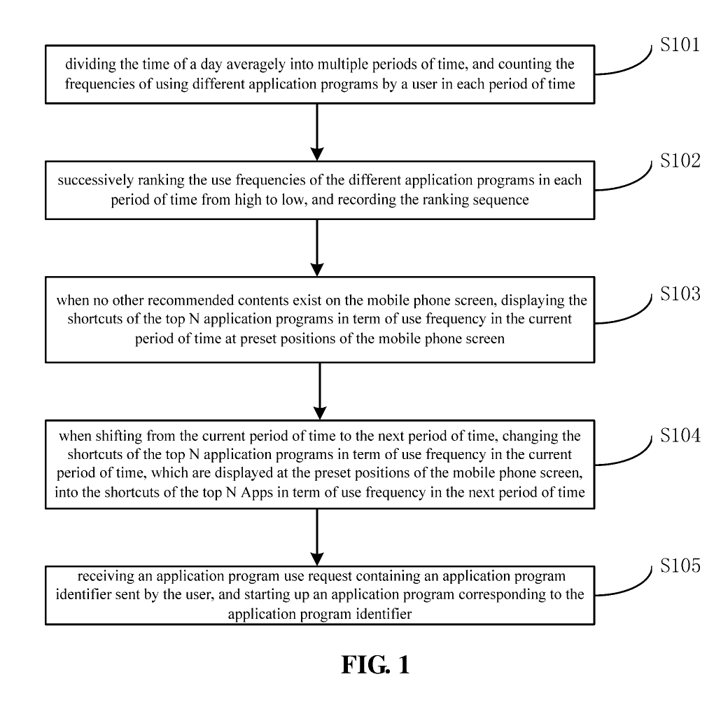

As shown in FIG. 1, the method for application program recommendation of the present invention includes the following steps:

S101: dividing the time of a day averagely into multiple periods of time, and counting the frequencies of using different application programs by a user in each period of time.

For example, by taking every half hour as one period, the usage time of a mobile phone in one day can be divided into 48 periods, marking the periods as T1-T48; and the frequencies of using the application programs in each period of time is recorded in T1-T48.

S102: successively ranking the use frequencies of the different application programs in each period of time from high to low, and recording the ranking sequence; and ranking (APP1-APPn) the application programs used by the user in each period of time in T1-T48 from high to low according to the use frequencies.

S103: when no other recommended contents exist on the mobile phone screen, displaying the shortcuts of the top N application programs in term of usage frequency in the current period of time at preset positions of the mobile phone screen.\

When no interrupting prompt (for example, videos and the like according to personal preferences of a user) is displayed on the mobile phone screen, icons of the top N application programs with the highest use frequencies in the current period of time are displayed at the preset positions, for example, at the lower-left corner of a locked screen, of the mobile phone screen.

When the user does not use any application program in a certain period of time, still displaying the shortcuts of the N application programs lastly displayed before this period of time at the preset positions of the mobile phone screen.

S104: when shifting from the current period of time to the next period of time, changing the shortcuts of the top N application programs in term of usage frequency in the current period of time, which are displayed at the preset positions of the mobile phone screen, into the shortcuts of the top N application programs in term of usage frequency in the next period of time.

S105: receiving an application program use request containing an application program identifier sent by the user, and enabling an application program corresponding to the application program identifier.

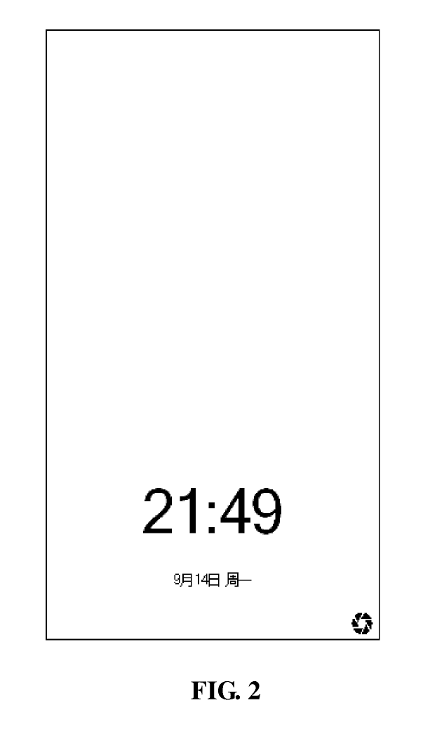

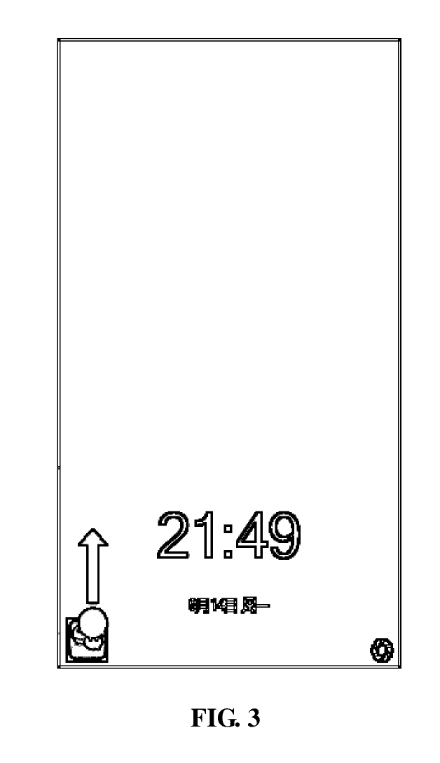

In the prior art, a common mobile phone screen display diagram, as shown in FIG. 2, only displays basic information of time, date, week and the like; however, after the use of the method of the present invention, the shortcuts of specific application programs can be displayed on the mobile phone screen according to the habit/preference of a user in different periods of time, as shown in FIG. 3, the user can quickly open an application program probably to be used on the mobile phone screen.

According to the method for application program recommendation of the present invention, on the basis of a certain rule each user follows to use different application programs, in accordance with the use preferences of the user in different periods of time, for example, checking road conditions on a map and weather conditions every morning or using e-mail, WeChat and the like in working hours, the icons of the application programs are displayed on the mobile phone screen according to the use frequencies to ensure that the user can start a application program frequently used in the current period of time in the shortest time. The method of the present invention saves the time of the user for finding an application program to be started one by one on the mobile phone desktop, and the application program needed by the user can be quickly presented on the mobile phone screen by only counting the habits of the user in a complete cycle (e.g., 24 hours), thereby optimizing the user experience.

### Embodiment II

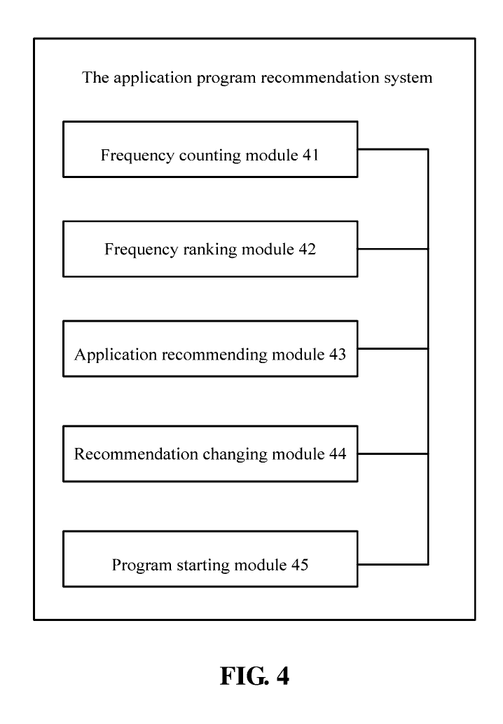

As shown in FIG. 4, the system for application program recommendation of the present invention includes: a frequency counting module 41, which is used for averagely dividing the time of a day into multiple periods of time, and counting the frequencies of using different application programs by a user in each period of time; a frequency ranking module 42, which is used for successively ranking the use frequencies of the different application programs in each period of time from high to low, and recording the ranking sequence; and an application recommending module 43, which is used for, when no other recommended contents exist on the mobile phone screen, displaying the shortcuts of the top N application programs in term of usage frequency in the current period of time at preset positions of the mobile phone screen.

The system also includes a recommendation changing module 44, which is used for, when shifting from the current period of time to the next period of time, changing the shortcuts of the top N application programs in term of usage frequency in the current period of time, which are displayed at the preset positions of the mobile phone screen, into the shortcuts of the top N application programs in term of usage frequency in the next period of time.

When the user does not use any application program in a certain period of time, the shortcuts of the N application programs previously displayed before this period of time are still displayed at the preset positions of the mobile phone screen.

The system also includes a program enabling module 45, which is used for receiving an application program use request containing an application program identifier sent by the user, and enabling an application program corresponding to the application program identifier.

According to the system for application program recommendation of the present invention, on the basis of a certain rule each user follows to use different application programs, in accordance with the use preferences of the user in different periods of time, for example, checking road conditions on a map and weather conditions every morning or using e-mail, WeChat and the like in working hours, the icons of the application programs are displayed on the mobile phone screen according to the use frequencies to ensure that the user can start an application program frequently used in the current period of time in the shortest time. The system of the present invention saves the time of the user for finding an application program to be started one by one on the mobile phone desktop, and the application program needed by the user can be quickly presented on the mobile phone screen by only counting the habits of the user in a complete cycle (e.g., 24 hours), thereby optimizing the user experience.

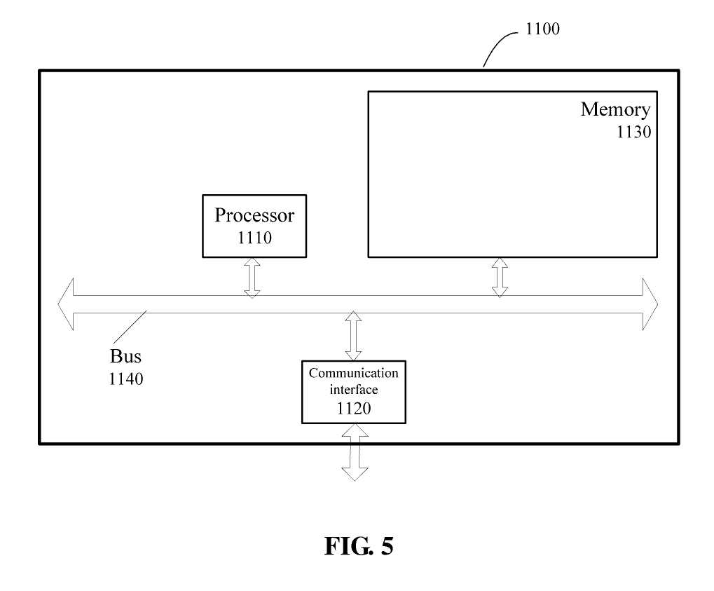

FIG. 5 is a block diagram of an electronic device which can implement a method for application program recommendation according to the present invention. The network device 1100 may be a host server, a personal computer (PC), or a portable computer or terminal and the like with computing power. The specific embodiments of the present invention do not limit concrete implementation of computing nodes.

The electronic device 1100 comprises a processor 1110, a communications interface 1120, a memory (memory array) 1130 and a bus 1140, wherein the processor 1110, the communications interface 1120 and the memory 1130 communicate with one another through the bus 1140.

The communications interface 1120 is used for communicating with a network element, wherein the network element comprises, for example, a virtual machine management center, shared storage and the like.

The processor 1110 is used for executing programs. The processor 1110 may be a central processing unit (CPU), or an ASIC (Application Specific Integrated Circuit), or one or more integrated circuits configured to implement the embodiments of the present invention.

The memory 1130 is used for storing files. The memory 1130 may comprise a high-speed RAM memory, and may also comprise a non-volatile memory, for example, at least one disk memory. The memory 1130 also can be a memory array. The memory 1130 may also be partitioned into blocks, and the blocks can be combined into a virtual volume according to a certain rule.

In a possible embodiment, the above-mentioned programs may be program codes comprising computer operating instructions, which causes the at least one processor to: averagely divide the time of a day into multiple periods of time, and count the frequencies of using different application programs by a user in each period of time; successively rank the use frequencies of the different application programs in each period of time from high to low, and record the ranking sequence; and when no other recommended contents exist on the mobile phone screen, display the shortcuts of the top N application programs in term of usage frequency in the current period of time at preset positions of the mobile phone screen.

In a possible embodiment, execution of the instructions by the at least one processor further causes the at least one processor to: when shifting from the current period of time to the next period of time, change the shortcuts of the top N application programs in term of usage frequency in the current period of time, which are displayed at the preset positions of the mobile phone screen, into the shortcuts of the top N application programs in term of usage frequency in the next period of time.

When the user does not use any application program in a certain period of time, the shortcuts of the N application programs previously displayed before this period of time are still displayed at the preset positions of the mobile phone screen.

In a possible embodiment, execution of the instructions by the at least one processor further causes the at least one processor to: receive an application program use request containing an application program identifier sent by the user, and enable an application program corresponding to the application program identifier.

A non-transitory computer-readable storage medium can store executable instructions that, when executed by an electronic device with a touch-sensitive display, cause the electronic device to averagely divide the time of a day into multiple periods of time, and count the frequencies of using different application programs by a user in each period of time; successively rank the use frequencies of the different application programs in each period of time from high to low, and record the ranking sequence; and when no other recommended contents exist on the mobile phone screen, display the shortcuts of the top N application programs in term of usage frequency in the current period of time at preset positions of the mobile phone screen.

The present invention may have various embodiments in different forms, the technical solution of the present invention is illustrated above by taking FIG. 1-FIG. 4 as examples with reference to the accompanying drawings, and this does not mean that the specific examples applied by the present invention can only be limited to specific processes or an embodiment structure; and it will be appreciated by those skilled in the art that the above-mentioned specific embodiments are just some examples of a variety of preferred usages, and any embodiment embodying the claims of the present invention shall be in the scope claimed by the technical solution of the present invention.

Finally, it should be explained that: what mentioned above are only preferred embodiments of the present invention, and are not used for limiting the present invention; and although the present invention is described in details with reference to the above-mentioned embodiments, those skilled in the part still can modify the technical solution recorded by the above-mentioned embodiments, or equivalently replace part of the technical characteristics therein. Within the spirit and principle of the present invention, any modification, equivalent replacement, improvement, etc., shall be included in the protection scope of the present invention.

What is claimed is:

1. A method for application program recommendation, comprising:
dividing the time of a day averagely into multiple periods of time, and counting the frequencies of using different application programs by a user in each period of time;
successively ranking the use frequencies of the different application programs from high to low in each period of time, and recording the ranking sequence; and
when no other recommended contents exist on the mobile phone screen, displaying at preset positions of the mobile phone screen, the shortcuts of the top N application programs in term of usage frequency in the current period of time.

2. The method according to claim 1, further comprising:
when shifting from the current period of time to the next period of time, changing the shortcuts of the top N application programs in term of usage frequency in the current period of time, which are displayed at the preset positions of the mobile phone screen, into the shortcuts of the top N application programs in term of usage frequency in the next period of time.

3. The method according to claim 1, wherein, when the user does not use any application program in a certain period of time, the shortcuts of N application programs previously displayed before this period of time are still displayed at the preset positions of the mobile phone screen.

4. The method according to claim 1, further comprising:
receiving an application program use request sent by the user, the application program use request containing an application program identifier, and enabling an application program corresponding to the application program identifier.

5. An electronic device for application program recommendation, comprising:
at least one processor; and
a memory communicably connected with the at least one processor for storing instructions executable by the at least one processor, wherein execution of the instructions by the at least one processor causes the at least one processor to:
averagely divide the time of a day into multiple periods of time, and count the frequencies of using different application programs by a user in each period of time;
successively rank the use frequencies of the different application programs in each period of time from high to low, and record the ranking sequence; and
when no other recommended contents exist on the mobile phone screen, display the shortcuts of the top N application programs in term of usage frequency in the current period of time at preset positions of the mobile phone screen.

6. The electronic device according to claim 5, wherein execution of the instructions by the at least one processor further causes the at least one processor to:
when shifting from the current period of time to the next period of time, change the shortcuts of the top N application programs in term of usage frequency in the current period of time, which are displayed at the preset positions of the mobile phone screen, into the shortcuts of the top N application programs in term of usage frequency in the next period of time.

7. The electronic device according to claim 5, wherein, when the user does not use any application program in a certain period of time, the shortcuts of the N application programs previously displayed before this period of time are still displayed at the preset positions of the mobile phone screen.

8. The electronic device according to claim 5, wherein execution of the instructions by the at least one processor further causes the at least one processor to:
receive an application program use request containing an application program identifier sent by the user, and enable an application program corresponding to the application program identifier.

9. A non-transitory computer-readable storage medium storing executable instructions that, when executed by an electronic device with a touch-sensitive display, cause the electronic device to:
averagely divide the time of a day into multiple periods of time, and count the frequencies of using different application programs by a user in each period of time
successively rank the use frequencies of the different application programs in each period of time from high to low, and record the ranking sequence; and
when no other recommended contents exist on the mobile phone screen, display the shortcuts of the top N application programs in term of usage frequency in the current period of time at preset positions of the mobile phone screen.
